(19) United States
(12) Patent Application Publication
(10) Pub. No.: US 2007/0103383 A1
(43) Pub. Date: May 10, 2007

(54) Displaying a user name by a secondary display of a notebook computer

(75) Inventors: Stephen A. Sposato, Lafayette, CA (US); Anthony P. Petronelli, San Jose, CA (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/258,609

(22) Filed: Oct. 25, 2005

(51) Int. Cl. G09G 5/00

(52) U.S. Cl. 345/1.1

(57) ABSTRACT

A notebook computer comprises a notebook computer lid, a notebook computer display viewable on a face of the notebook computer lid, and a secondary display viewable on an opposite face of the notebook computer lid. A processor causes the secondary display to display a user name in response to a user input received by a user input device of the notebook computer.

### FIELD OF THE DISCLOSURE

The present disclosure relates to dual display notebook computers.

### BACKGROUND

In many business situations, a participant of a business meeting is unfamiliar with names of other participants of the meeting. In these situations, each participant may distribute his/her business cards to other participants who do not know his/her name. However, if many participants are unknown to each other, some participants may end up with a stack of other participants' business cards. Having a stack of cards to flip through when addressing an unfamiliar participant in the meeting is undesirable.

### BRIEF DESCRIPTION OF THE DRAWINGS

The present disclosure is pointed out with particularity in the appended claims. However, other features are described in the following detailed description in conjunction with the accompanying drawings in which:

FIG. 1 is a block diagram of a notebook computer according to an embodiment of the present invention;

FIG. 2 is an illustration of an embodiment of a notebook computer whose secondary display displays an advertising message;

FIG. 3 is an illustration of an embodiment of a notebook computer whose secondary display displays computer status information;

FIG. 4 is an illustration of FIG. 3 from the user's perspective;

FIG. 5 is an illustration of an embodiment of a notebook computer whose secondary display displays a user name; and

FIG. 6 is a diagram of an embodiment of a general computer system.

### DETAILED DESCRIPTION OF THE DRAWINGS

Disclosed herein are embodiments that allow users of portable computers with a lid to display their name on a secondary display attached to the back of the lid. The secondary display is viewable by others facing the back of the lid. Thus, others can identify a user using his/her portable computer in a business meeting, for example. However, the name is inhibited from being displayed by the secondary display until a particular user input is received. This is beneficial to avoid situations in which users may not wish to identify themselves (e.g. when a user is using his/her portable computer in public places such an airport or a coffee shop). In place of the user's name, the secondary display may display either an advertisement, a public relation message or an offer-for-sale message for public consumption when the user is using his/her portable computer in these situations. When the lid is closed, the secondary display may display information in an upside-down orientation relative to the orientation of the name. This information may include status information for the portable computer such as battery status information and/or wireless access point status information. Other information that may be displayed by the secondary display, in any orientation, comprises an indicator of a new email message, an indicator of a new voice mail message, an indicator of a new fax message, an indicator of a new calendar item message, an indicator of a new instant message, a wireless signal strength, a wireless provider name, or any combination thereof.

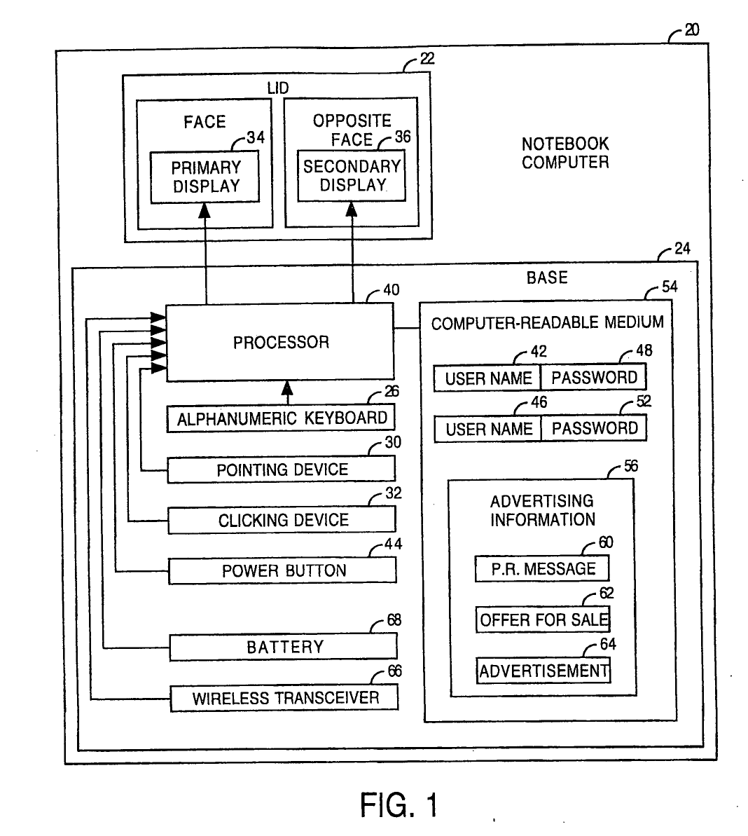

FIG. 1 is a block diagram of a notebook computer 20 according to an embodiment of the present invention. The notebook computer 20 comprises a notebook computer lid 22 that pivots with respect to a base 24. The base 24 comprises one or more user input devices such as an alphanumeric keyboard 26, a pointing device 30 such as a touch pad or a pointing stick, and a clicking device 32 such as a click button.

A primary display 34 is viewable on a face of the notebook computer lid 22. In a particular embodiment, the primary display 34 is a notebook computer display that is viewable by a user of the alphanumeric keyboard 26, the pointing device 30 and the clicking device 32 when the notebook computer lid 22 is pivoted to an open position. The primary display 34 may be unviewable when the notebook computer lid 22 is pivoted to a closed position.

A secondary display 36 is viewable on an opposite face of the notebook computer lid 22. The secondary display 36 may be either unviewable or not easily viewed by a user of the alphanumeric keyboard 26, the pointing device 30 and the clicking device 32 when the notebook computer lid 22 is pivoted to an open position. However, the secondary display 36 is viewable by other individuals who are face-to-face with the user when the notebook computer lid 22 is pivoted to an open position. The secondary display 36 is viewable when the notebook computer lid 22 is pivoted to a closed position.

In some embodiments, the secondary display 36 is smaller than the primary display 34 in at least one dimension (e.g. height or width) and/or has a smaller display area. The secondary display 36 may have the same or less resolution than the primary display 34, and/or may have the same number or fewer colors than the primary display 34. The secondary display 36 may comprise either a monochrome or color liquid crystal display (LCD), an electronic paper display (non-scrollable or flashing), an organic light emitting diode (OLED) display, or a plasma display. The secondary display 36 may be capable of displaying text and/or graphics. Textual and/or graphical information may be scrolled and/or flashing by the secondary display 36. The secondary display 36 may be back-lit. The secondary display 36 may be either permanently attached to or removable from the notebook computer lid 22.

A processor 40 provides control logic to control what information is displayed by the secondary display 36 based on one or more particular conditions. The herein-disclosed acts performed by the processor 40 may be directed by computer-readable program code stored by a computer-readable medium. The program code may be part of an Operating System (OS), Basic Input/Output System (BIOS), or other software.

The processor 40 causes the secondary display 36 to display a first user name 42 in response to a first user input received by a user input device. Preferably, the processor 40 causes the secondary display 36 to be absent the first user name 42 until the first user input is received. For example, until the first user input is received, the processor 40 can cause the secondary display 36 to be absent the first user name 42 during periods commenced by either an act of receiving a power-up command (e.g. via either a power button 44 or an operating system command), an act of receiving a restart command, an act of receiving a wake-from-sleep or wake-from-standby command, or an act of sensing that the notebook computer lid 22 has been pivoted from a closed position to an open position.

The processor 40 can cause the secondary display 36 to display a second user name 46, which differs from the first user name 42, in response to a second user input received by the user input device. This feature supports situations where the notebook computer 20 is shared by multiple employees of a company, and each employee may potentially need to identify himself/herself in his/her own meeting.

The first user input may comprise a point-and-click input (e.g. on a “turn name on” button displayed by the primary display 34) or a keyed input (e.g. using one of the twelve “F” function keys of the keyboard 26).

Either in addition to or as an alternative to the above inputs, the first user input may comprise a first password 48 so that the secondary display 36 is absent the first user name 42 until the first password 48 is received from a user. The first password 48 may be specific to a first user having the first user name 42. The second user input may comprise a second password 52 so that the secondary display 36 is absent the second user name 46 until the second password 52 is received from a user. The second password 52 may be specific to a second user having the second user name 46. The user names 42 and 46 and the passwords 48 and 52 can be stored in a computer-readable medium 54. In general, the processor 40 and the medium 54 can support any number of different user names with corresponding passwords. Use of passwords is beneficial to mitigate a possibility of a user misrepresenting his/her identity.

In response to a subsequent user input received by a user input device, the processor 40 can cause the user name to be removed from the secondary display 36. The subsequent user input may comprise a point-and-click input (e.g. on a “turn name off” button displayed by the primary display 34) or a keyed input (e.g. using one of the twelve “F” function keys of the keyboard 26). Optionally, the processor 40 causes the user name to be removed from the secondary display 36 upon either an act of receiving a power-down command (e.g. via either the power button 44 or an operating system command), an act of receiving a sleep or standby command, or an act of pivoting the notebook computer lid 22 to a closed position.

The processor 40 can cause the secondary display 36 to display information other than a user name for one or more particular conditions. The non-user-name information can be displayed during the time period before the user name is displayed based on a user input, and/or during a time period after the user name has been removed from the secondary display 36. The non-user-name information can include advertising information 56 or status information for the notebook computer 20.

Examples of the advertising information 56 include, but are not limited to, a public relation message 60 from an owner of the notebook computer 20 and/or an employer of a user having the user name, an offer-for-sale message 62 from the owner of the notebook computer 20 and/or the employer of the user having the user name, or another type of advertisement 64. The advertising information 56 can be received via a wireless transceiver 66 and stored in the medium 54.

If the offer-for-sale message 62 is displayed, the processor 40 can cause the primary display 34 to display a user interface receptive to input of contact information for a potential customer. The potential customer may be a viewer of the secondary display 36 who expresses interest in the offer to the user. The offer may be for a telecommunication service such as Digital Subscriber Line (DSL), Internet Protocol Television (IPTV) or cellular phone service, for example. Contact information for the potential customer is communicated from the notebook computer 20 to a communication device for a salesperson. The contact information may include a name and a telephone number or an e-mail address, for example. The salesperson can use the contact information to contact the potential customer and close a sale.

The user interface may be displayed in response to a user input received by a user input device. Examples of the user input include a point-and-click input (e.g. on an “employee referral” button displayed by the primary display 34) or a keyed input (e.g. using one of the twelve “F” function keys of the keyboard 26).

The status information may be displayed with one or more icons, graphics and text. Examples of the status information include, but are not limited to, an indicator of a presence of a wireless access carrier that is in range of the wireless transceiver 66 of the notebook computer 20, a wireless provider name, an indicator of a signal strength of the wireless access carrier, an indication that the wireless access carrier has been authenticated as a trusted carrier by the processor 40, battery charge information indicating a level of charge in a battery 68, a date and a time. The wireless access carrier may communicate with the wireless transceiver 66 using WiFi or an 802.11-based standard, for example.

The secondary display 36 may be capable of displaying information in either a first orientation or a second orientation, the second orientation being upside-down relative to the first orientation. In this case, the processor 40 can cause the secondary display 36 to display the user name and the advertising information 56 in the first orientation, and the status information in the second orientation.

Optionally, the user is permitted to display on the secondary display 36 any message he/she inputs using notebook computer 20. Further, the message displayed by the secondary display 36 can include a news ticker or a stock ticker. As another option, the secondary display 36 may continue to display a user name, advertising information, computer status information, or other information if removed from the notebook computer lid 22. In this case, a module that includes the secondary display 36 may have its own battery and may communicate wirelessly with the processor 40 (e.g. using Bluetooth).

The processor 40 can cause the secondary display 36 to display an indicator of a new email message, an indicator of a new voice mail message, an indicator of a new fax message, an indicator of a new calendar item message, an indicator of a new instant message or any combination thereof.

Optionally, any information being displayed by the secondary display 36 is also viewable via a graphical user interface (GUI) on the primary display 34. The information currently displayed on the secondary display 36 may be shown in a small display region of the primary display 34, e.g. in a corner of the primary display 34. The GUI may provide user-selectable controls or icons that enable the user to configure which one or more information items are to be displayed by the secondary display 36. For example, the GUI may include a first icon to turn on/off displaying a wireless provider name, a second icon to turn on/off displaying a wireless signal strength, a third icon to turn on/off displaying the battery life, and other icons to turn on/off the other herein-disclosed information items. Any of the icons can be selected using point-and-click commands.

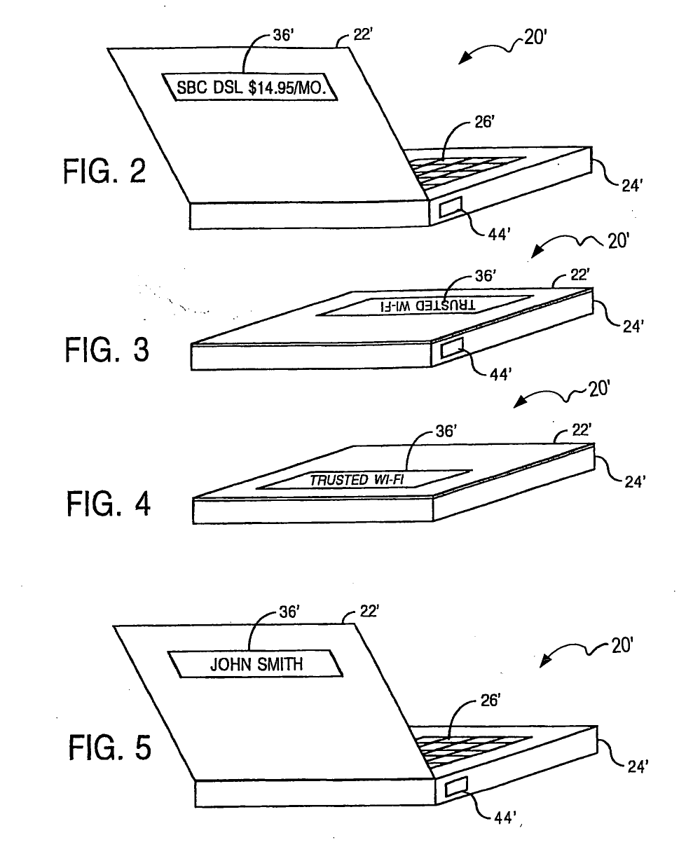

FIGS. 2 to 5 illustrate a hypothetical sequence of use of an embodiment of the notebook computer 20.

Consider a telecommunication worker who is to fly to a business meeting. When at an airport, the worker turns-on a notebook computer 20′ using a power button 44′. Being in a public place, the worker does not wish to display his/her name. Thus, as shown in FIG. 2, a secondary display 36′ displays an advertising message that is viewable by other people in airport.

After the worker has completed using the notebook computer 20′ at the airport, the worker turns the notebook computer 20′ off and pivots a lid 22′ to a closed position as shown in FIG. 3. In this state, the secondary display 36′ displays computer status information such as an indication that a trusted wireless site is within range of the notebook computer 20′. The computer status information in FIG. 3 is upside-down relative to the advertising message in FIG. 2 in order to be more-easily readable by the worker (whose perspective is shown in FIG. 4).

After arriving at the meeting, the worker opens and turns-on the notebook computer 20′ using the power button 44′. After the worker has provided particular user input, the secondary display 36′ displays his name as shown in FIG. 5. Other participants of the meeting can identify the worker by viewing the secondary display 36′.

It will be apparent to those skilled in the art that the disclosed inventions may be modified in numerous ways and may assume many embodiments other than the preferred forms specifically set out and described herein. For example, any of the components depicted as being housed by or attached to the base 24 in FIG. 1 can be housed by or attached to the lid 22 instead.

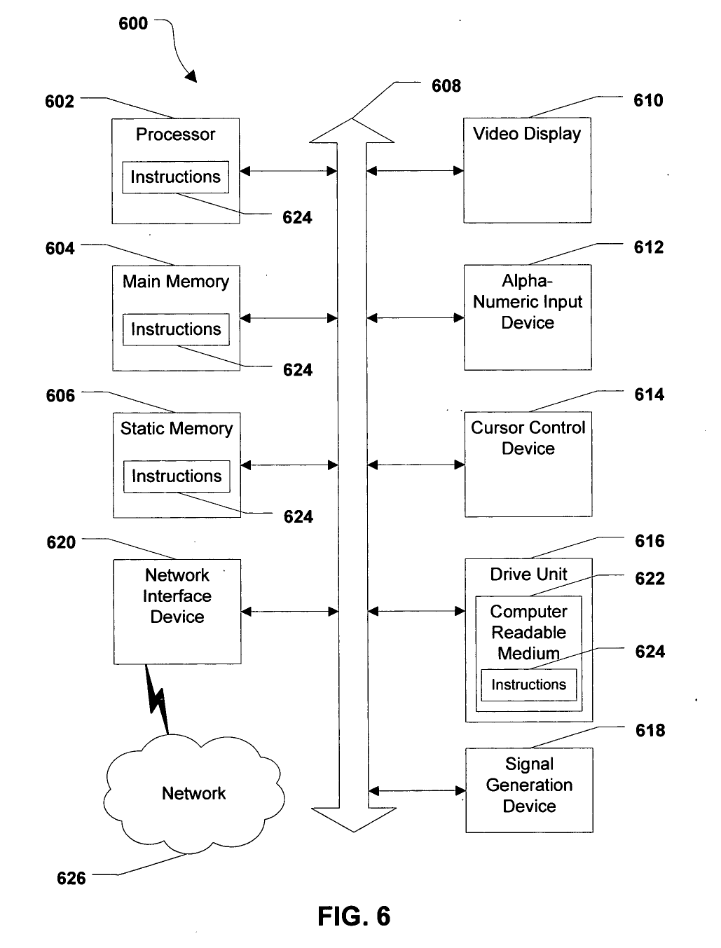

Referring to FIG. 6, an illustrative embodiment of a general computer system is shown and is designated 600. In a particular embodiment, the computer shown in FIG. 1 through FIG. 5 can include one or more of the elements described in conjunction with the computer system 600. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 can include a main memory 604 and a static memory 606, that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A notebook computer comprising:
a notebook computer lid;
a notebook computer display viewable on a face of the notebook computer lid;
a secondary display viewable on an opposite face of the notebook computer lid;
a user input device; and
a processor to cause the secondary display to display a first user name in response to a first user input received by the user input device.

2. The notebook computer of claim 1, wherein the processor causes the secondary display to be absent the first user name during a period from receiving a power-up command until the first user input is received.

3. The notebook computer of claim 1, wherein the processor causes the secondary display to be absent the first user name during a period from receiving a restart command until the first user input is received.

4. The notebook computer of claim 1, wherein the first user input comprises a password, and wherein the processor causes the secondary display to be absent the first user name until the password is received.

5. The notebook computer of claim 1, wherein the processor causes the secondary display to display a second user name, which differs from the first user name, in response to a second user input received by the user input device.

6. The notebook computer of claim 1, wherein the processor causes the secondary display to display a public relation message of an employer of a user having the first user name.

7. The notebook computer of claim 1, wherein the processor causes the secondary display to display an offer for sale made by an employer of a user having the first user name.

8. The notebook computer of claim 7, wherein the offer is for a telecommunication service.

9. The notebook computer of claim 7, wherein the processor causes the notebook computer display to display a user interface in response to a second user input received by the user input device, the user interface receptive to input of contact information of a viewer of the secondary display who expresses interest in the offer to the user.

10. The notebook computer of claim 1, wherein the secondary display is capable of displaying information in either a first orientation or a second orientation, the second orientation being upside-down relative to the first orientation, wherein the processor is to cause the secondary display to display the first user name in the first orientation, and when the notebook computer lid is in a closed position, the processor is to cause the secondary display to display information in the second orientation.

11. The notebook computer of claim 10, wherein the information comprises an advertisement.

12. The notebook computer of claim 10, wherein the information comprises notebook computer status information.

13. The notebook computer of claim 12, further comprising a wireless transceiver, wherein the notebook computer status information comprises an indicator of a presence of a wireless access carrier that is in range of the wireless transceiver and has been authenticated by the processor as a trusted carrier.

14. The notebook computer of claim 12, wherein the notebook computer status information comprises battery charge information.

15. The notebook computer of claim 12, wherein the notebook computer status information comprises an indicator of a presence of a wireless access carrier.

16. The notebook computer of claim 12, wherein the notebook computer status information comprises an indicator of a signal strength of a wireless access carrier.

17. The notebook computer of claim 12, wherein the notebook computer status information comprises an indicator of at least one of a new email message, a new voice mail message, a new fax message, a new calendar item message, or a new instant message.

18. The notebook computer of claim 12, wherein the notebook computer status information comprises an icon or a graphic.

19. The notebook computer of claim 10, wherein the information comprises scrolling text.

20. The notebook computer of claim 10, wherein the information comprises flashing text.

21. The notebook computer of claim 1, wherein the secondary display is smaller than notebook computer display.

22. The notebook computer of claim 1, wherein the secondary display is a liquid crystal display.

23. The notebook computer of claim 1, wherein the secondary display comprises at least one of electronic paper display, an organic light emitting diode display or a plasma display.

24. The notebook computer of claim 1, wherein the user input device comprises an alphanumeric keyboard.

25. The notebook computer of claim 1, wherein the processor is to cause the secondary display to display user-configurable information, and wherein the user-configurable information displayed in the secondary display is viewable in the primary display.
